(19) United States
(12) Patent Application Publication
(10) Pub. No.: US 2001/0010025 A1
(43) Pub. Date: Jul. 26, 2001

(54) Rapid image capture system

(76) Inventors: Randy L. Knust, The Woodlands, TX (US); Eric Schoppe, Conroe, TX (US); Richard Garza, Texas City, TX (US)

Correspondence Address: Tim Cook, Felsman, Bradley, Vaden, Gunter & Dillon, LLP, Suite 1100, One Riverway, Houston, TX, 77056-1982, US

(21) Appl. No.: 09/735,181

(22) Filed: Dec. 12, 2000

Related U.S. Application Data
(63) Continuation-in-part of application No. 09/483,854, filed on Jan. 17, 2000.

(51) Int. Cl. A63F 9/24; A63F 13/00; G06F 17/00; G06F 19/00

(52) U.S. Cl. 700/91; 463/30; 463/33

(57) ABSTRACT

A distributed image capture system for industry is provided. The invention includes a system of electronic computer hardware and software that can acquire a video (analog or digital) image of an identification card, voucher chit, receipt, or other desired image at any of a plurality of acquisition stations throughout an establishment. This is done by placing a document or object to be imaged onto video imager at a convenient location. The document or object is acquired, and the image so captured is transmitted along a communications channel to a central computer system, where the image is catalogued with a unique identification number or is defaulted to the date and time of capture.

This is a continuation in part of U.S. Pat. application Ser. No. 09/483,854 filed Jan. 17, 2000.

### FIELD OF THE INVENTION

The present invention relates generally to the field of systems which capture, store, and retrieve video or graphical images and, more particularly, to a system and method for recording and retrieving images useful in an identification or economic transaction with the aid of a computer.

### BACKGROUND OF THE INVENTION

The parent application of this application, Ser. No. 09/483,854, describes an application of the present invention to the casino and gaming field. The preferred embodiment of that application comprises a system of cameras, linked together through a multiplexed system, for acquiring images of bets placed throughout a casino. In that application, an image of a stack of gaming chips is captured at a number of gambling positions at a plurality of gaming tables. The images are then multiplexed in series to a central computer for interpretation and use.

The present invention applies that general technique of video image manipulation to the capture, storage, and retrieval of images of photo identification and economic or financial transactions in a similar fashion. This application is particularly useful in any industry that requires the capture or copying of a photo ID such as a driver's license. By way of example and not by way of limitation, the present invention may find application in industries such as the hospitality industry where financial transactions typically take place in a variety of locations within a single establishment.

The advantage of the invention is the ability to quickly capture and store images from up to 56 different locations into one computer located anywhere on the premises. This ability eliminates the need for a personal computer and scanner at every station where an image will be captured. Also, this saves the hardware and software costs, maintenance, and training associated with personal computers and scanners.

In today's business environment, any financial transaction, such as cashing a check at a bank or setting up a line of credit at a casino, requires the presentation of a driver's license for ID and signature verification. The current invention allows for the instant capture of the ID for storage and retrieval. This is a valuable security and customer service tool. A known patron or customer would not have to supply an ID for every transaction. The ID would already be on file and could quickly be retrieved for identification or demographic purposes, if needed.

In addition to ID verification for banks, etc., the hospitality industry can benefit from the invention. More particularly, a single hotel may have many places where guests may charge goods and services throughout the hotel. The first and most visible of these locations is the front desk, where guests check in and typically have an impression of a credit card taken. Hotels also commonly have associated within the same establishment one or more restaurants and bars, where a guest may charge meals, drinks, and the like, to his room or credit card, simply by indicating his room number and providing a signature. Similarly, a guest may charge room service, spa services, gift shop products, and pay tips to certain hotel employees, all in a similar manner of charging such goods and services to his room number.

Unfortunately, mistakes happen, and sometimes errors are made in charging expenses to a particular room. A guest may put the wrong room number on a charge voucher, or even try to get goods and services without paying for them. Some guests honestly forget receiving certain goods and services, or one guest may place a charge on a room account without informing others who are staying at the hotel on the same room account. However, when such mistakes are made, a guest may challenge a particular charge on his bill. Hotels typically do not contest such a challenge if the charge does not exceed some predetermined dollar value. One reason for this acquiescence is that the hotel administrator charged with dealing with the guest does not have ready access to the particular charge voucher that would readily prove the charge entry. To keep all charge vouchers in hard copy close at hand at the checkout desk of a hotel would be a paperwork nightmare. Writing off lower value charges when challenged is a common practice throughout the hospitality industry, and this practice costs the industry millions of dollars in legitimate income annually.

Thus, there remains a need for a system and method of providing ready access to the images of all financial transactions of the various stations within an establishment without the need to keep mountains of charge vouchers available to clerks. Such a system should provide little additional administrative burden on personnel, and provide instantaneous verification of account charges.

### SUMMARY OF THE INVENTION

The system of the present invention addresses these and other needs and drawbacks in the art by providing a distributed image capture system. The present invention will find use in any application where the capture, storage, and retrieval of identification, financial or other transactions will be useful.

The invention includes a system of electronic computer hardware and software that can acquire a video (analog or digital) image of an identification card, voucher chit, receipt, or other desired image at any of a plurality of acquisition stations throughout an establishment. The document or object to be imaged is placed onto a video imager at the station where the transaction takes place, or other convenient location. An image of the document or object is captured and transmitted along a communications channel to a central computer system, where the image is catalogued with a unique identification number or by date and time and stored where appropriate. If there is not a unique ID number known or available, the current date and time will be assigned to the captured image.

At some later time, the document or object can quickly be retrieved for verification by the unique identification number or by date and time. This will alleviate any challenge or dispute brought to attention and should save considerable time and money.

The system includes a video multiplexer having a plurality (such as, e.g., eight) video inputs and one or more video displays. The multiplexer may be replicated at various distributed locations within the system, in a manner similar to that described in Ser. No. 09/483,854, which is incorporation herein by reference. These multiplexers may preferably be linked together to send a signal representative of the object from any station in the establishment to a central computer for image acquisition and storage.

The system can also send data from the various distributed stations input by other devices such as a magnetic card reader or keypad into the central computer. This is carried out using a computer serial board designed to accept data from the magnetic card reader and keypad. These boards can be daisy-chained together and data can be sent through a serial cable from any station in the establishment to one central computer for identification, storage, and later retrieval.

These and other features and objects of this invention will be apparent to those skilled in the art from a review of the following detailed description and the accompanying drawings.

### BRIEF DESCRIPTION OF THE DRAWINGS

FIG. 1 is an overall schematic diagram of the rapid image capture system of this invention.

FIG. 2 is a schematic diagram of the video multiplexer system of the invention.

FIG. 3 is a schematic diagram of a serial board adapted to implement the present invention.

### DETAILED DESCRIPTION OF A PREFERRED EMBODIMENT

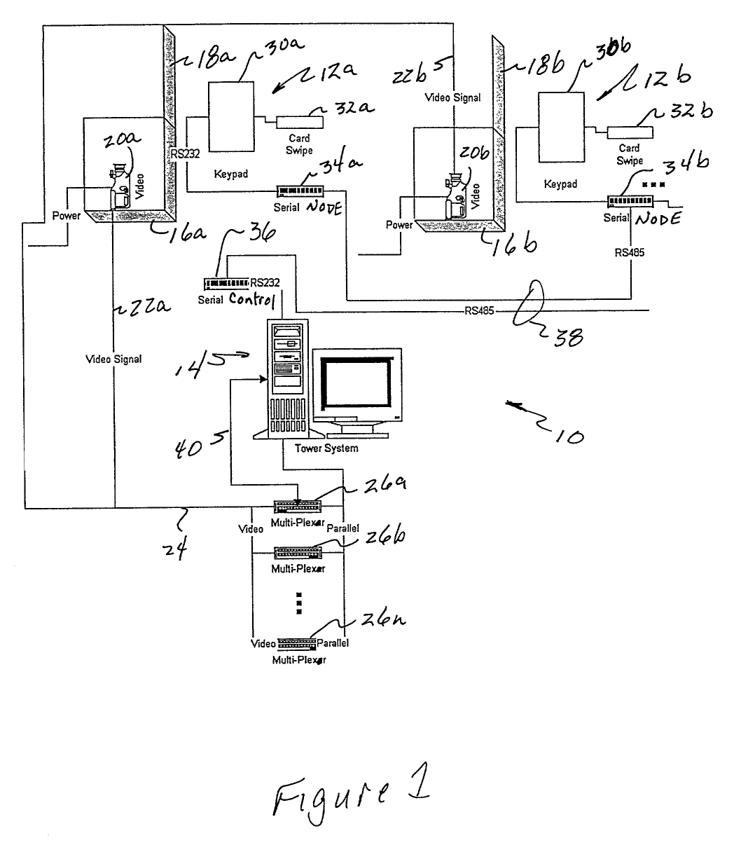

FIG. 1 shows an overall schematic diagram of the general system 10 using the rapid image capture system of the invention. The following description is directed to application of the invention to a hospitality establishment, but as described above the system may be adapted to other applications.

The system comprises primarily a plurality of stations 12a, 12b, etc., distributed throughout an establishment, and a central computer 14. Anywhere within an establishment that requires presenting an ID or offers credit transactions may have such a station 12. Each station 12 includes an image box 16, 16a, 16b, etc. for the acquisition of a video image for capture and storage. For example, an establishment may wish to capture an image of the guest's signature from a driver's license or credit card, as well as the image of the driver's license or credit card itself. The system may also include a pressure sensitive pad for the guest to directly input a signature. Similarly, every time a credit transaction takes place, a credit slip or voucher may also be placed on an image box and the image of the credit transaction proof may be captured. The image is captured by placing the specific document (not shown) on the image box 16, a lid 18 is closed over the document, and an image is taken by a video device such as a camera 20a, 20b, etc. Any convenient identifier, providing a unique code to link the image to an account, may then be entered into the keypad. If an identifier is not available, the image will store with a date and time file name.

The image taken by the video device 20 is sent by a video image line 22a, 22b etc. directly or to a fiber optic backbone 24 to one or more video multiplexers 26a, 26b, . . . 26n, described below in greater detail. Although other communications connections may be used, the fiber optic backbone is preferred for adequate speed, bandwidth and signal distance. The multiplexers 26 feed the video images in a coherent fashion to the central computer 14 for archival purposes.

In addition to the video image capture components, the system 10 further includes the capability of selected data input from other input means such as a keypad 30a, 30b, etc. and/or a card swipe device 32a, 32b, etc. The keypad 30a and the card swipe device 32a feed data to a serial board 34a, with each station 12 having a dedicated serial board. The serial board 34 is described below in greater detail. Data from each serial board is acquired by a serial control 36 in a polling fashion, and fed coherently to the central computer. The data is carried from the serial boards 34 to the serial control 36 over conventional twisted pair connections 38.

The video image multiplexer 26 and the serial board 34 will now be described in greater detail.

Video Image Multiplexer (VM)

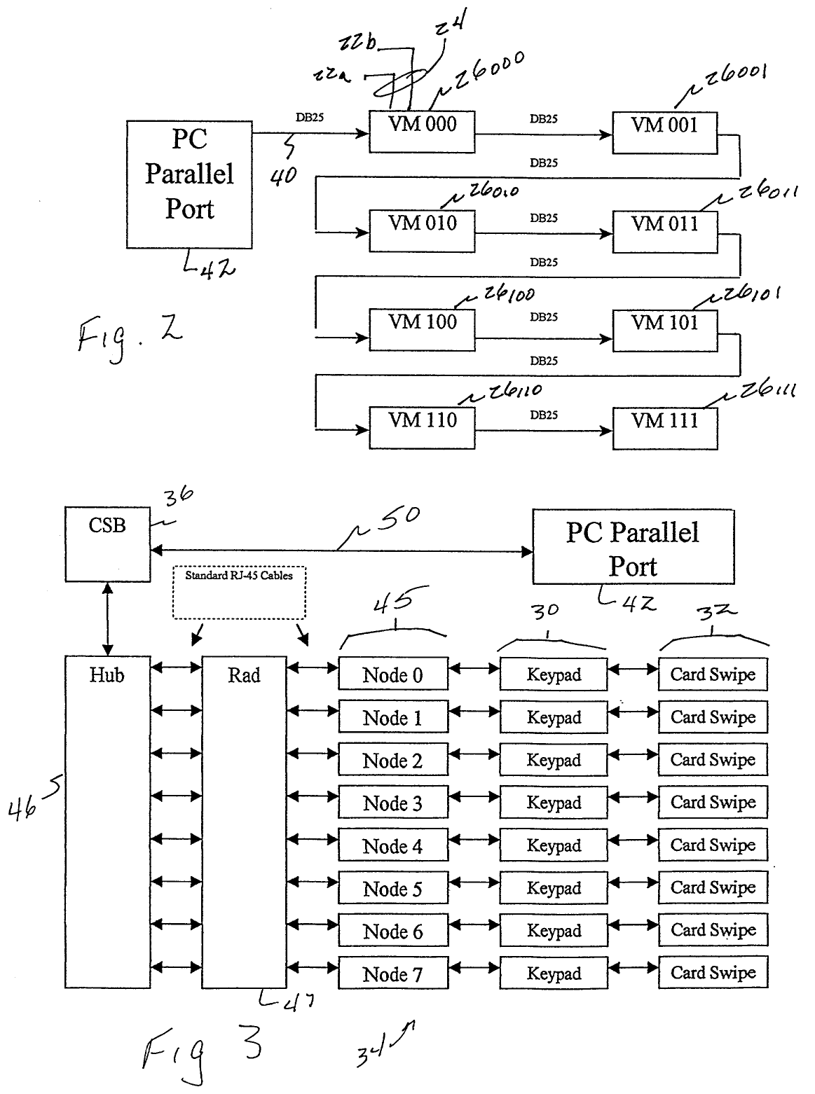

The video image multiplexer arrangement is depicted in FIG. 2. The video image multiplexer 26 is a video signal routing device, preferably with eight inputs and a single output. The video image preferably conforms to the National Television Standards Committee (NTSC) format, rather than RGB, but other appropriate standard image formats may be used. The video image multiplexer 26 may be used with seven other multiplexers in series. The control for the multiplexing and sequencing of the multiplexers is provided by a control line 40 (See FIG. 1) from a PC-type parallel port. Once the multiplexers 26 are coupled as depicted in FIG. 2, with control provided from the central computer 14 and inputs supplied from the cameras 20, then each multiplexer is capable of choosing from any of 57 video image signals.

As shown in FIG. 2, the multiplexers are preferably coupled in series. Control for the system is provided by the central computer 14 by way of a parallel port 42. The multiplexers provide themselves with an address dynamically; thus, the first multiplexer in the series will automatically address itself as 26₀₀₀, the next will automatically address itself as 26₀₀₁, etc.

Eight VM's can be connected together to get one video out from 57 incoming video signals. A parallel port on an IBM compatible PC is used to make the choice of video signals to output. Description of the interplay of the parallel port on an IBM compatible personal computer may be found at “Interfacing the IBM PC Parallel Port” by Zhahai Stewart, 1994, incorporated herein by reference.

Serial Board

The serial board 34 (SB), shown schematically in FIG. 3, is a device which receives serial instructions from the central computer 14 or from another SB and outputs different types of information serially back to the central computer 14 or to another SB. The types of information handled by the SB may include magnetic card strip data, keypad data, and the like. Each keypad 30, used only with each node serial board (described below), comprises a 16 character by 2 row module for displaying numbers and text. It is backlit with LED's built into the module. There are 16 buttons in a 4×4 pattern for inputting data. Each button may be programmed to display text on the LCD module. The interface between the keypad and its dedicated SB is through a 16-pin header found on the bottom of the keypad with the corresponding connector marked “Keypad” on the serial board. The interface is useful only for communication between the node SB and the keypad. Each card swipe device 32 is used to read data from a standard magnetic card with data on track 1, track 2, or tracks 1 and 2. There are two LED's on top of the device. One green, which flashes every few seconds to let the user know that it is turned on, and the other red, which is used to signal a bad read. There is also a piezzoelectric device, which chirps when the unit is turned on as well as when a read is detected.

The information from the SB to the central computer 14 is information such as which button on the keypad 30 was pushed, what number sequence was entered into the keypad 30, and what information was read from a magnetic card by the card swipe device 32. The instructions from the central computer 14 to the SB includes information to be displayed on an LCD screen on the keypad. These functions are not handled by just one SB. At least 2 SB's are needed to perform these functions but there may be as many as 9 SB's at one time.

As shown in FIG. 1, there are two basic types of SB. There must always be one control SB 44 and from one to eight node SB's 45. A 1×8 port hub 46 is included to accommodate more than one node SB. Each of the node SB's 45 communicates with the hub 46 via a rad box 47, which simply couples the signal into fiber optic cables for transmission. The Control is in charge of communicating with the Nodes. The control communicates continuously in a polling fashion with the nodes to see if any node has information to send back such as key presses and magnetic card information. The control stops communicating with the nodes if the central computer 14 requests the use of the serial port to send information to a node. At that point, the control listens only for the central computer 14 command. The control determines that the command is valid and passes it on to one or more of the nodes or it determines that the command is not a known command or format and returns an error to the central computer 14. At the termination of the command, the control resumes its communication with the nodes.

The nodes interface with the peripherals that the user has access to. For example, a node SB checks the card reader for card information, and it checks the keys on the keypad for key presses. Once any of these events is detected and identified, the node frames the information in the proper format and waits for the next contact from the control as described above, at which point the information is sent to the control and on to the central computer 14. The node is also interrupted every time a command is sent from the control. The node address is checked against its own in order to identify commands which apply to it. These include commands such as place words on the LCD character module and program a key on the Keypad, for example.

The SB's communicate using RS-232 for communication from the central computer to the control SB. The first connection is from the central computer 14 to the first SB over a connection 50.

The main function of the control SB 44 is to communicate with the nodes 45 and the exchange is time critical. Consequently, a request for access to the port must be requested, and acknowledgment received, before sending instruction to the control 44 from the central computer. For access, the central computer sends “RS” (Request to Send). This instruction is sent repeatedly until an “OK” is received in the incoming serial line. At that point, the control serial board has stopped polling the nodes and is ready to receive an instruction from the PC.

The following are valid instructions from and to the SB's:

From control SB to the central computer:

Card Swipe:
[xCddd] - x is the table number 0 to 7, “ddd” is a representation of a variable number

of characters read from the Card swipe.

Keypad:
[xKy] - x is the table number 0 to 7, y is the Keypad number 0×00 to 0×0F.

From PC to control SB:

| LCD Character Module (Display on screen): | |
|---|---|
| [xCabcdefghij ... ddd] | |
| a - Store | must be ‘0’ |
| b - Key | must be ‘0’ |
| c - Clear Top | ‘c’ = Clear top row before displaying anything, ‘0’ = don't |

clear

| | |
|---|---|
| d - Clear Bottom | ‘c’ = Clear bottom row before displayint anything, ‘0’ = don't |

clear

| | |
|---|---|
| e - Start Cursor | ‘c’ = Display data starting at current cursor location, ‘0’ = |

Display data starting at “Start Row” and “Start Col” location

| | |
|---|---|
| f - Start Row | If “At Cursor” is ‘c’ then row to start display of data |
| g - Start Col | if “At Cursor” is ‘c’ then column to start display of data |
| h - End Cursor | ‘r’ = After display of data cursor moves right one space, ‘0’ |

= Set cursor to row “End Row” and column “End Col”.

| | |
|---|---|
| i - End Row | If “End Cursor” is ‘0’ then row to move cursor to after display |

of data

| | |
|---|---|
| j - End Col | If “End Cursor” is ‘0’ then column to move cursor to after |

display of data

| ddd - Data to be displayed. Must be at least 1 character long and no more than 16. | |
|---|---|
| Key Pad (Program Key): | |
| [xCabcdefghij ... ddd] | |
| a - Store | must be ‘p’ |
| b - Key | Number of Key to program 0×00 to 0×0F |
| c - Clear Top | ‘c’ Clear top row before displaying anything, ‘0’ = don't |
| clear | |
| d - Clear Bottom | ‘c’ = Clear bottom row before displayint anything, ‘0’ = don't |

clear

| | |
|---|---|
| e - Start Cursor | ‘c’ = Display data starting at current cursor location, ‘0’ = |

Display data starting at “Start Row” and “Start Col” location

| | |
|---|---|
| f - Start Row | If “At Cursor” is ‘c’ then row to start display of data |
| g - Start Col | if “At Cursor” is ‘c’ then column to start display of data |
| h - End Cursor | ‘r’ = After display of data cursor moves right one space, ‘0’ |

= Set cursor to row “End Row” and column “End Col”.

| | |
|---|---|
| i - End Row | If “End Cursor” is ‘0’ then row to move cursor to after display |

of data

| | |
|---|---|
| j - End Col | If “End Cursor” is ‘0’ then column to move cursor to after |

display of data

ddd - Data to be displayed. Must be at least 1 character long and less than 14.

Thus, the present invention provides a system and method for acquiring and storing images of pertinent documents or objects through out a multi-station establishment. The documents or objects are imaged and stored, uniquely identified with a specific account or by date and time, and are available for immediate retrieval for verification. The cost of the installation and operation of the system just described can easily be recouped by the establishment in a short time through savings in storage, retrieval time and write offs that would otherwise be lost through challenges.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

We claim:

1. A system for capturing video images comprising:
a. a first plurality of video image boxes coupled in series, the plurality of video image boxes providing a first video output;
b. a second plurality of video image boxes coupled in series, the plurality of video image boxes providing a second video output;
c. a multiplexer to select between the first and second video outputs, and to provide a multiplexed video output; and
d. a central computer adapted to receive and store the multiplexed video output.

2. The system of claim 1, further comprising data input means to assign a unique identification code or date and time to the first video output.

3. The system of claim 2, wherein the data input means comprises a keypad.

4. The system claim 2, wherein the data input means comprises card swipe device.

5. The system of claim 1, wherein the video images represent a document or object.

6. The system of claim 1, further comprising data input means to assign a unique identification code or date and time to the first video output, and wherein the first video output represents a document or object, and wherein the unique identification code or date and time is assigned by the data input means to more than one captured video image.

7. A method of capturing video images comprising the steps of:
a. locating a central computer;
b. coupling a plurality of video image boxes, located at spaced apart locations, to the central computer;
c. acquiring a first video image of a first document or object at one of the plurality of video image boxes, while assigning a unique identification code or date and time to the first video image; and
d. storing the acquired first video image and unique identification code or date and time in the central computer.

8. The method of claim 7, further comprising the steps of:
a. acquiring a second video image of a second document or object at another of the plurality of video image boxes, while assigning the unique identification code or date and time to the second video image; and
b. storing the acquiring second video image and unique identification code or date and time in the central computer.

9. The method of claim 8, further comprising the steps of:
a. querying the central computer using the unique identification code or date and time; and
b. retrieving the first and second video images from the central computer in response to the query.

10. The method of claim 8, further comprising the step of manually inputting data associated with the unique identification code.

11. A system for capturing video images comprising:
a. a plurality of video image boxes coupled in series adapted to capture video images;
b. a plurality of digital data input means, one each of the digital data input means associated with each of the plurality of video image boxes, the digital data input means adapted to provide a unique identification number to an image captured by a video image box; and
c. a central computer adapted to receive and store video images with provided unique identification numbers.
